(19) United States
(12) Patent Application Publication
(10) Pub. No.: US 2025/0073956 A1
(43) Pub. Date: Mar. 6, 2025

(54) HOLDING MECHANISM OF SLICER, CRYSTAL BAR CONVEYING STRUCTURE AND SLICER

(71) Applicant: ZHEJIANG JINGSHENG M & E CO., LTD, Shaoxing (CN)

(72) Inventors: Jianwei CAO, Shaoxing (CN); Liang ZHU, Shaoxing (CN); Jiabin LU, Shaoxing (CN); Jinrong WANG, Shaoxing (CN); Feng ZHOU, Shaoxing (CN); Linjian FU, Shaoxing (CN); Yuan CAO, Shaoxing (CN); Yuanyao CHENG, Shaoxing (CN)

(21) Appl. No.: 18/236,131

(22) PCT Filed: May 22, 2023
(86) PCT No.: PCT/CN2023/095553

§ 371 Date: Aug. 22, 2023

(30) Foreign Application Priority Data
Feb. 1, 2023 (CN) 202310096759.3

(51) Int. Cl. B28D 5/00

(52) U.S. Cl. CPC B28D 5/0082

(57) ABSTRACT

A holding mechanism of a slicer, a crystal bar conveying structure and a slicer are provided. The holding mechanism of a slicer includes a holding seat and at least two limiting members. The at least two limiting members are movably disposed on the holding seat. An outer surface of the holding seat is provided with an accommodating groove. When the at least two limiting members are in the avoiding state, at least a part of each of the at least two limiting members is accommodated in the accommodating groove, so as to give way to a crystal bar holder in a moving process of the crystal bar holder. When the at least two limiting members are in the limiting state, at least a part of each of the at least two limiting members protrudes out from the outer surface of the holding seat to abut against the crystal bar holder.

### CROSS-REFERENCE TO RELATED APPLICATIONS

This application is an U.S. national phase application under 35 U.S.C. § 371 based upon international patent application No. PCT/CN2023/095553 filed on May 22, 2023, which claims priority to Chinese patent application No. 202310096759.3, filed on Feb. 1, 2023, and titled “HOLDING MECHANISM OF SLICER, CRYSTAL BAR CONVEYING STRUCTURE AND SLICER”, the content of which is hereby incorporated by reference in its entirety.

### TECHNICAL FIELD

The present disclosure relates to the field of crystal bar slicing, in particular, to a holding mechanism of a slicer, a crystal bar conveying structure and a slicer.

### BACKGROUND

Conventionally, a front sidewall of a slicer is provided with a feeding port and an unloading port, and a back sidewall of the slicer is further provided with a feeding port and an unloading port, so that a crystal bar can be conveyed by a crystal bar holder both from the front sidewall and the back sidewall of the slicer. During the above process, the crystal bar holder is moved on a holding mechanism. The crystal bar holder is guided by the holding mechanism from the feeding port and the unloading port to a slicing chamber, and then clamped by the holding mechanism.

Correspondingly, when the crystal bar holder is moved on the holding mechanism, a position of the crystal bar holder should be limited to ensure that the crystal bar holder enters the slicing chamber accurately. The crystal bar holder may enter the slicing chamber from a front end of the holding mechanism or a back end of the holding mechanism. For example, when the crystal bar holder moves backward from the front end of the holding mechanism, the back end of the holding mechanism is provided with a limiting structure. When the crystal bar holder enters the slicing chamber, the limiting structure can contact the crystal bar holder to limit a position of the crystal bar holder, so that the crystal bar can be smoothly sliced. However, when the crystal bar holder moves forward from the back end of the holding mechanism, the limiting structure will block the crystal bar holder, thus preventing the crystal bar holder from entering the slicing chamber. Therefore, the mechanical limiting structure in the related art is difficult to meet a requirement of bidirectional feeding of the crystal bar holder.

In view of above, at present, a sensor can be provided on the holding mechanism by the applicant in an actual production process, so that movement of the crystal bar holder can be controlled by an electronic method. However, it is well known that sensing accuracy of the sensor on the position of the crystal bar holder is low. Therefore, the electronic control method has a poor effect on limiting position of the crystal bar holder, which affects a slicing effect of the crystal bar.

### SUMMARY

According to various embodiments of the present disclosure, the present disclosure provides a holding mechanism of a slicer, a crystal bar conveying structure and the slicer

The present disclosure provides the holding mechanism of the slicer. The holding mechanism of the slicer includes a holding seat and at least two limiting members, and the at least two limiting members are movably disposed on the holding seat. An outer surface of the holding seat is provided with an accommodating groove, and each of the at least two limiting members has an avoiding state and a limiting state. When the at least two limiting members are in the avoiding state, at least a part of each of the at least two limiting members is accommodated in the accommodating groove, so as to give way to a crystal bar holder in a moving process of the crystal bar holder. When the at least two limiting members are in the limiting state, at least a part of each of the at least two limiting members protrudes out from the outer surface of the holding seat to abut against the crystal bar holder. The at least two limiting members includes a first limiting member and a second limiting member, and the first limiting member and the second liming member are disposed at intervals along a length direction of the holding seat.

In an embodiment, each of the at least two limiting members includes an articulated end and a free end. The articulated end of the at least two limiting members is pivotally connected to an inner surface of the accommodating groove. A torsional spring is sleeved on the articulated end of the at least two limiting members, and two ends of the torsional spring are located on the inner surface of the accommodating groove and the free end, respectively.

In an embodiment, the inner surface of the accommodating groove is provided with a locking part. When the at least two limiting members are in the avoiding state, the free ends of the at least two limiting members are locked to the locking part.

In an embodiment, when the at least two limiting members are in the avoiding state, the at least two limiting members abut against the inner surface of the accommodating groove. In an embodiment, the inner surface of the accommodating groove is provided with a blocking member. When the at least two limiting members are in the avoiding state, the at least two limiting members abut against the blocking member.

In an embodiment, the holding seat is provided a first proximity switch and a second proximity switch. The first proximity switch is configured to detect a distance between the first proximity switch and a free end of the first limiting member, and the second proximity switch is configured to detect a distance between the second proximity switch and a free end of the second limiting member. Both the first proximity switch and the second proximity switch are electrically connected to a control board, and the control board is electrically connected to an alarm. When both the free end of the first limiting member and the free end of the second limiting member are detected by the first proximity switch and the second proximity switch, respectively, the alarm sounds. When both the free end of the first limiting member and the free end of the second limiting member are not detected by the first proximity switch and the second proximity switch, respectively, the alarm sounds.

In an embodiment, each of the at least two limiting members includes a free end and a positioning end. The positioning end of each of the at least two limiting members is fixed to the inner surface of the accommodating groove, and the free end of each of the at least two limiting members is capable of getting in or getting out of the accommodating groove, so that each of at least two limiting members can switch between the avoiding state and the limiting state.

In an embodiment, each of the at least two limiting member includes a limiting block and a recovering spring. An end of the recovering spring is defined as the positioning end, and the other end of the recovering spring is disposed on the limiting block, so that the limiting block is defined as the free end.

In an embodiment, the inner surface of the accommodating groove is provided with a locking part. When the at least two limiting members are in the avoiding state, the limiting block is locked at the locking part.

In an embodiment, a part of an outer surface of the limiting block fits with the inner surface of the accommodating groove, so that the inner surface of the accommodating groove is capable of guiding movement of the limiting block.

In an embodiment, each of the at least two limiting members is an extendable tube, an end of the extendable tube is defined as the free end of the at least two limiting members, and the other end of the extendable tube is defined as the positioning end of the at least two limiting members.

In an embodiment, the inner surface of the accommodating groove is provided with a first detector switch and a second detector switch. The first detector switch is configured to detect a state of the first limiting member, and the second detector switch is configured to detect a state of the second limiting member. Both the first detector switch and the second detector switch are electrically connected to a control board, and the control board is electrically connected to an alarm. When both the first limiting member and the second limiting member are in the avoiding state and detected by the first detector switch and the second detector switch, respectively, the alarm sounds. When both the first limiting member and the second limiting member are in the limiting state and detected by the first detector switch and the second detector switch, respectively, the alarm sounds.

In an embodiment, the holding seat is provided with an electric actuator, and the at least two limiting members are disposed on the electric actuator. The electric actuator is configured to control the at least two limiting members to switch between the avoiding state and the limiting state.

In an embodiment, the holding seat is provided with a lifting cylinder configured to lift the crystal bar holder. A third proximity switch is disposed on a bottom surface of the holding seat, and the third proximity switch is configured to detect a distance between the crystal bar holder and the bottom surface of the holding seat.

In an embodiment, the holding mechanism further includes a connecting plate. An edge of a top end of the connecting plate is fixed to an edge of a bottom end of the holding seat. An edge of a bottom end of the connecting plate extends to define a sliding plate. The sliding plate is provided with an idler wheel, and the sliding plate is located at a side of the connecting plate adjacent to the holding seat.

The present disclosure further provides a crystal bar conveying structure. The crystal bar conveying structure includes the holding mechanism and the crystal bar holder. The crystal bar holder is movably disposed on a bottom of the holding seat along the length direction of the holding seat.

The present disclosure further provides a slicer. The slicer includes a slicing cabinet and the crystal bar conveying structure. Both a front sidewall of the slicing cabinet and a back sidewall of the slicing cabinet are provided with ports, and the ports are configured to allow a material to get in or out.

Details of one or more embodiments of the present disclosure will be set forth in the accompanying drawings and description hereinafter. Other features, objects, and advantages of the present disclosure will become apparent from the specification, the accompanying drawings, and the claims.

### BRIEF DESCRIPTION OF THE DRAWINGS

In order to better describe and illustrate those embodiments and/or examples of the invention disclosed herein, reference may be made to one or more of the accompanying drawings. The additional details or examples used to describe the accompanying drawings should not be considered a limitation on the scope of any of the disclosed inventions, the embodiments and/or examples presently described, and the best mode of these inventions as presently understood.

FIG. 1 is a stereoscopic diagram of a crystal bar conveying structure in some embodiments of the present disclosure.

FIG. 2 is an enlargement diagram of portion A in FIG. 1.

FIG. 3 is a stereoscopic diagram of a crystal bar conveying structure in some embodiments of the present disclosure (connecting plate and slide plate are not shown).

FIG. 4 is an enlargement diagram of portion B in FIG. 3.

FIG. 5 is an enlargement diagram of portion in FIG. 3.

FIG. 6 is a stereoscopic diagram of a holding mechanism of a slicer in some embodiments of the present disclosure.

FIG. 7 is an enlargement diagram of portion D in FIG. 6.

FIG. 8 is a stereoscopic diagram of a crystal bar holder in some embodiments of

the present disclosure.

FIG. 9 is a front view of a crystal bar holder in some embodiments of the present disclosure.

FIG. 10 is a sectional view of a crystal bar conveying structure in some embodiments of the present disclosure.

FIG. 11 is a schematic diagram of working principle of a limiting member in a holding mechanism of a slicer in an avoiding state in some embodiments of the present disclosure.

FIG. 12 is a schematic diagram showing working principle of a limiting member in a holding mechanism of a slicer in a limiting state in some embodiments of the present disclosure.

FIG. 13 is a schematic diagram showing a holding seat in some embodiments of the present disclosure.

FIG. 14 is a schematic diagram of a holding seat in some embodiments of the present disclosure.

FIG. 15 is a schematic diagram of a slicer in some embodiments of the present disclosure.

In the figures, 100 represents a slicer: 101 represents a crystal bar conveying structure: 102 represents a slicing cabinet: 103 represents a slicing chamber: 104 represents a port: 1 represents a holding mechanism: 11 represents a holding seat: 110 represents an accommodating groove: 111 represents a first accommodating groove: 1111 represents a first avoiding port: 1110 represents a locking part: 1112 represents a first locking hole: 112 represents a second accommodating groove: 1121 represents a second avoiding port: 113 represents a cylinder groove: 114 represents a blocking member: 120 represents a limiting member: 120A represents an articulated end: 120B represents a free end: 12 represents a first limiting member: 121 represents a first articulated end: 1210 represents a torsional spring: 1211 represents a first torsional spring: 122 represents a first free end: 1221 represents a first proximity switch: 123 represents a first detector switch: 13 represents a second limiting member: 131 represents a second articulated end; 132 represents a second free end: 1321 represents a second proximity switch: 133 represents a second detector switch: 14 represents a connecting plate; 141 represents a sliding plate: 1411 represents an idler wheel: 142 represents an avoiding notch: 15 represents a limiting bar: 16 represents a limiting block: 170 represents a positioning end: 17 represents a recovering spring: 18 represents a control board: 19 represents an alarm: 2 represents a crystal bar holder; 21 represents a limiting rib: 22 represents a lifting step: 23 represents a sliding groove: 24 represents a limiting groove: 25 represents a lifting cylinder: 26 represents a third proximity switch: and 30 represents an electric actuator.

### DETAILED DESCRIPTION

In order to make objects, technical solutions and advantages of the present disclosure more clearly understood, the specific embodiment of the present disclosure is described in detail in the following with reference to the accompanying drawings. Many specific details are set out in the following description in order to fully understand the present disclosure. However, the present disclosure may be implemented in many other ways different from those described herein, and those skilled in the art may make similar improvements without violating the content of the present disclosure, so the present disclosure is not limited by the specific embodiments disclosed below.

In the description of the present application, it is to be understood that the terms “center”, “longitudinal”, “transverse”, “length”, “width”, “thickness”, “up,” “down,” “front,” “back,” “left ”, “right”, “vertical”, “horizontal”, “top”, “bottom”, “inner”, “outer”, “clockwise”, “anticlockwise ”, “axial”, “radial”, “circumferential”, and the like indicate an orientation or positional relationship based on the orientation or positional relationship shown in the figures. These terms are used only for the convenience and simplicity of describing the present disclosure and are not intended to indicate or imply that the device or element referred to must have a particular orientation, be constructed and operated in a particular orientation, and therefore are not to be construed as a limitation of the present disclosure.

Furthermore, the terms “first” and “second” are used for descriptive purposes only and are not to be understood as indicating or implying relative importance or implicitly specifying the number of technical features indicated. Thus, a feature defined with “first”, “second” may expressly or impliedly include at least one such feature. In the description of the present disclosure, “plurality” means at least two, e.g., two, three, etc., unless otherwise expressly and specifically limited.

In this disclosure, unless otherwise expressly specified and limited, the terms “mounting”, “communicated”, “connected”, “fixed”, etc. shall be understood broadly. For example, it may be a fixed connection, a removable connection, or a one-piece connection: it may be a mechanical connection or an electrical connection: it may be a direct connection or an indirect connection via an intermediate medium, and it may be a communication between two elements or an interactive relationship between the two elements, unless expressly limited otherwise. To one of ordinary skill in the art, the specific meaning of the above terms in this disclosure may be understood on a case-by-case basis.

In the present disclosure, unless otherwise expressly specified and limited, the first feature “on” or “below” the second feature may be a direct contact between the first and second features, or an indirect contact between the first and second features through an intermediate medium. Furthermore, the first feature being “on”, “above” and “disposed on” the second feature may be that the first feature is directly above or diagonally above the second feature, or simply that the first feature is horizontally higher than the second feature. The first feature is “below”, “under” and “underneath” the second feature may be that the first feature is directly below or diagonally below the second feature, or simply that the first feature is less horizontal than the second feature.

It is noted that when an element is said to be “fixed to” or “disposed on” another element, it may be directly on the other element or there may be a centered element. When an element is said to be “connected” to another element, it may be directly connected to the other element or there may be both centered elements. As used herein, the terms “vertical”, “horizontal”, “top”, “bottom”, “left,” “right,” and similar expressions are used herein for illustrative purposes only and are not intended to be the exclusive means of implementation.

### First Embodiment

Referring to FIG. 1, in order to solve a problem that a holding mechanism cannot mechanically limit a position of a crystal bar holder without affecting the crystal bar holder entering into a slicing chamber of a slicer, the present embodiment provides a crystal bar conveying structure 101. The crystal bar conveying structure 101 includes a holding mechanism 1 and a crystal bar holder 2, and both the crystal bar holder 2 and the holding mechanism 1 can be in strip-shaped. The crystal bar holder 2 can be disposed on a bottom of the holding mechanism 1 and can be moved back and forth along an axis of the holding mechanism 1. That is, the crystal bar holder 2 can be moved along a length direction of the holding mechanism 1.

For ease of description, in the present embodiment, the holding mechanism 1 can sequentially include a front end of the holding mechanism 1 and a back end of the holding mechanism 1 along a direction of a movement of the crystal bar holder on the holding mechanism 1. Correspondingly, a holding seat 11 of the holding mechanism 1 can sequentially include a front end of the holding seat 11 and a back end of the holding seat 11.

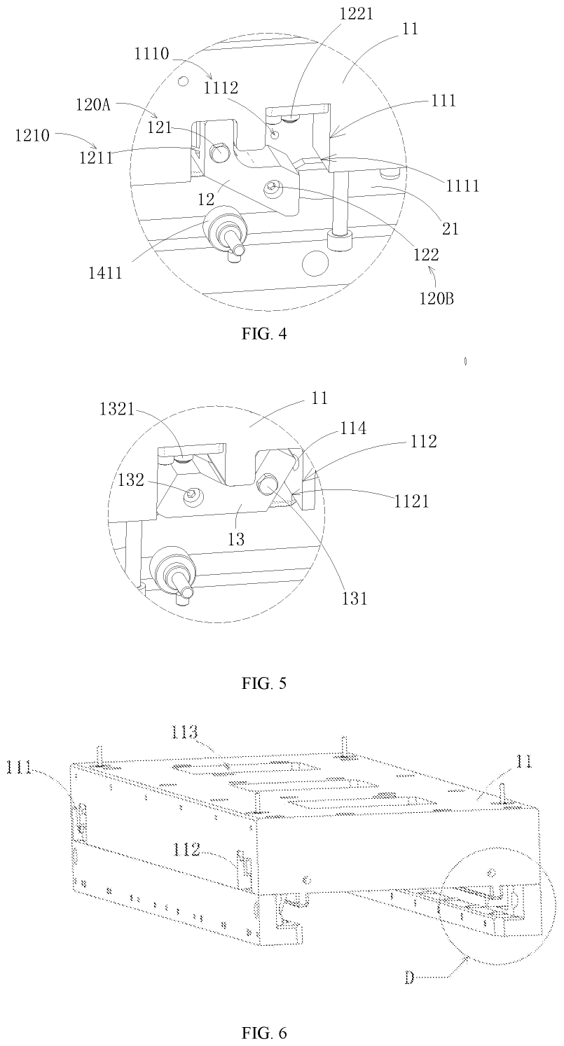

Referring to FIG. 3 to FIG. 5, specifically, the holding mechanism 1 includes the holding seat 11 and a limiting member 120, and the limiting member 120 is movably disposed on the holding seat 11. An outer surface of the holding seat 11 is provided with an accommodating groove 110, and the limiting member 120 can switch between an avoiding state and a limiting state via the accommodating groove 110. When the limiting member 120 is in the avoiding state, at least a part of the limiting member 120 is accommodated in the accommodating groove 110. When the limiting member 120 is in the limiting state, at least a part of the limiting member 120 protrudes out from the outer surface of the holding seat 11. The outer surface of holding seat 11 may be a side wall of the holding seat 11, a top wall of the holding seat 11, or a bottom wall of the holding seat 11.

In the present embodiment, the holding mechanism 1 includes a plurality of limiting members 120, including a first limiting member 12 and a second limiting member 13. The holding mechanism 1 includes a plurality of accommodating grooves 110, including a first accommodating groove 111 and a second accommodating groove 112. The first limiting member 12 can be movably disposed in the first accommodating groove 111 and the second limiting member 13 can be movably disposed in the second accommodating groove 112.

In a case that the first limiting member 12 is disposed at the front end of the holding seat 11 and the second limiting member 13 is disposed at the back end of the holding seat 11, the crystal bar holder 2 can move forward into the slicing chamber 103 from the back end of the holding seat 11. When the crystal bar holder 2 moves forward into the slicing chamber 103 from the back end of the holding seat 11, the second limiting member 13 is in the avoiding state, the crystal bar holder 2 will not be obstructed until the crystal bar holder 2 collides with the first limiting member 12 in the limiting state,, so that the first limiting member 12 can give way to the crystal bar holder 2. When the crystal bar holder 2 moves backwards from the front end of the holding seat 11, at least a part of the first limiting member 12 can be controlled to be accommodated in the accommodating groove 110, so as to switch the first limiting member 12 to the avoiding state. Thus, the first limiting member 12 can give way to the crystal bar holder 2, and avoid obstruction of the first limiting member 12 on movement of the crystal bar holder 2. In this way, the crystal bar holder 2 can cross the first limiting member 12 and get into the slicing chamber 103 until colliding with the second limiting member 13. At this time, the position of the crystal bar holder 2 can be limited by the second limiting member 13. By switching a state of the limiting member 120 between the avoiding state and the limiting state, it can be ensured that the crystal bar holder 2 can smoothly get into the slicing chamber 103 whether the crystal bar holder 2 moves from the front end to the back end of the holding seat 11 or from the back end to the front end of the holding seat 11. The limiting member 120 can play a role of mechanically limiting the position of the crystal bar holder 2 along one of the moving directions the crystal bar holder 2, thereby improving positioning accuracy of the crystal bar holder 2 and guaranteeing slicing quality of the crystal bar.

In some embodiments, both the first accommodating groove 111 and the second accommodating groove 112 can be located on a left sidewall of the holding seat 11. In some embodiments, both the first accommodating groove 111 and the second accommodating groove 112 can be located on a right sidewall of the holding seat 11. In some embodiments, the first accommodating groove 111 and the second accommodating groove 112 can be located on the left sidewall of the holding seat 11 and the right sidewall of the holding seat 11, respectively. That is, relative positions of the first accommodating groove 111 and the second accommodating groove 112 along a width direction of holding seat 11 are not limited. However, the first accommodating groove 111 and the second accommodating groove 112 are disposed at intervals along a length direction of the holding seat 11. Taking the present embodiment as an example, the left sidewall of the holding seat 11 can be provided with the first accommodating groove 111 and the second accommodating groove 112. The right sidewall of the holding seat 11 can be further provided with the first accommodating groove 111 and the second accommodating groove 112. The two first accommodating grooves 111 can be disposed adjacent to the front end of the holding seat 11, and the two second accommodating grooves 112 can be disposed adjacent to the back end of the holding seat 11, so that the two first accommodating grooves 111 can be located in front of the two second accommodating grooves 112. Accordingly, the first limiting member 12 can be located in front of the second limiting member 13, and the first limiting member 12 and the second liming member 13 can be disposed at intervals along the length direction of the holding seat 11. Since the holding seat 11 has a symmetrical structure, the present embodiment is described by taking the first accommodating groove 111 and the second accommodating groove 112 on the right sidewall of the holding seat 11 as an example.

In an embodiment, the right sidewall of holding seat 11 can be provided with one accommodating groove, and both the first limiting member 12 and the second limiting member 13 can be accommodated in the accommodating groove. Therefore, the number of the limiting members may be greater than the number of the accommodating grooves, and a plurality of limiting members may be accommodated in one accommodating groove.

In the present embodiment, each of the at least two limiting members can include an articulated end 120A and a free end 120B. For ease of distinction, various features in the present embodiment can be named as follows. The articulated end 120A of the first limiting member 12 can be defined as a first articulated end 121, and the free end 120B of the first limiting member 12 can be defined as a first free end 122. The articulated end 120A of the second limiting member 13 can be defined as a second articulated end 131, and the free end 120B of the second limiting member 13 can be defined as a second free end 132.

The first articulated end 121 of the first limiting member 12 can be pivotally connected to an inner surface of the first accommodating groove 111, so that a part of the first limiting member 12 at the first articulated end 121 can be accommodated in the first accommodating groove 111. The first accommodating groove 111 can extend to a bottom surface of the holding seat 11 to define a first avoiding port 1111. The first avoiding port 1111 can provide an active space for the first limiting member 12 to rotate up and down, thereby allowing the first free end 122 of the first limiting member 12 to get in or out of the first accommodating groove 111 through the first avoiding port 1111.

Similarly, the second articulated end 131 of the second limiting member 13 can be pivotally connected to an inner surface of the second accommodating groove 112. The second accommodating groove 112 can extend to the bottom surface of the holding seat 11 to define a second avoiding port 1121, thereby allowing the second free end 132 of the second limiting member 13 to get in or out of the second accommodating groove 112 through the second avoiding port 1121.

A right edge of a top end of the crystal bar holder 2 can be provided with a limiting rib 21, and the limiting rib 21 can extend along an axis of the crystal bar holder 2. When the first free end 122 of the first limiting member 12 is located below the first avoiding port 1111 (that is, a part of the first limiting member 12 protrudes from an edge of the sidewall of the holding seat 11 and the first limiting member 12 is in the limiting state), and the second limiting member 13 is accommodated in the second accommodating groove 112 (that is, the second limiting member 13 is in the avoiding state), the first free end 122 of the first limiting member 12 and a front end of the limiting rib 21 can be opposite to each other along the axis of the crystal bar holder 2, and the second limiting member 13 and the front end of the limiting rib 21 will not be opposite to each other along the axis of the crystal bar holder 2. Therefore at the same time. Therefore, the crystal bar holder 2 can slide forward from the back end of the holding seat 11 for to load a material during which the crystal bar holder 2 can slide cross the second limiting member 13 until the crystal bar holder 2 collides with and be limited by the first free end 122 of the first limiting member 12.

Similarly, in other embodiments, the first limiting member 12 can be accommodated in the first accommodating groove 111, that is, the first limiting member 12 is in the avoiding state. Moreover, the second free end 132 of the second limiting member 13 can be located below the second avoiding port 1121, that is, a part of the second limiting member 13 protrudes from the edge of the sidewall of the holding seat 11, and the second limiting member 13 is in the limiting state. At this time, the crystal bar holder 2 can slide backward from the front end of the holding seat 11. A back end of the limiting rib 21 can move cross the first limiting member 12 until the back end of the limiting rib 21 collides with and be limited by the second free end 132 of the second limiting member 13.

In view of above, in the present embodiment, the first limiting member 12 and the second limiting member 13 can be rotated, so that only one of the first free end 122 of the first limiting member 12 and the second free end 132 of the second limiting member 13 can be opposite to the end of the limiting rib 21. When the crystal bar holder 2 moves backward from the front end of the holding seat 11 or moves forward from the back end of the holding seat 11, neither the first limiting member 12 nor the second limiting member 13 will obstruct the crystal bar holder 2 from entering the slicing chamber. The first limiting member 12 and the second limiting member 13 can further bidirectionally and mechanically limit the position of the crystal bar holder 2, so that better the crystal bar holder 2 can have better limit accuracy in the slicing chamber, thus guaranteeing slicing quality of the crystal bar

It is contemplated that in some embodiments, the first limiting member 12 can move up and down in the first accommodating groove 111. The second limiting member 13 can move up and down in the second accommodating groove 112. In this way, a part of the first limiting member 12 can get in or out of the first accommodating groove 111 through the first avoiding port 1111, and a part of the second limiting member 13 can get in or out of the second accommodating groove 112 through the second avoiding port 1121. In this way, the first limiting member 12 and the second limiting member 13 can also bidirectionally and mechanically limit the crystal bar holder 2.

In the present embodiment, alternatively, a torsional spring 1210 can be sleeved on the articulated end of the limiting member 12, and two of the torsional spring 1210 can be located on the inner surface of the accommodating groove and the free end of the first limiting member 12, respectively. For ease of distinction, the torsional spring 1210 sleeved on the first articulated end 121 can be defined as a first torsional spring 1211, the torsional spring 1210 sleeved on the second articulated end 131 can be defined as a second torsional spring.

Two ends of the first torsional spring 1211 can be located on the inner surface of the first accommodating groove 111 and the first free end 122 of the first limiting member 12, respectively. The first torsional spring 1211 can provide a moving trend of the first free end 122 of the first limiting member 12 to rotate downwards to a position below the first avoiding port 1111. Since the first limiting member 12 can further have a moving trend to rotate downwards to the position below the first avoiding port 1111 under an action of gravity of the first limiting member 12, the first free end 122 of the first limiting member 12 can separate from the first accommodating groove 111 as much as possible under dual effects of the gravity of the first limiting member 12 and the first torsional spring 1211. Therefore, the first free end 122 of the first limiting member 12 can be guaranteed to be opposite to the front end of limiting rib 21, thus playing a role of sufficiently limiting a position of the limiting rib 21.

Similarly, two ends of the second torsional spring can be located on the inner surface of the second accommodating groove 112 and the second free end 132 of the second limiting member 13, respectively. The second torsional spring can provide a moving trend for the second free end 132 of the second limiting member 13 to rotate downwards to a position below the second avoiding port 1121. The second free end 132 of the second limiting member 13 can separate from the second accommodating groove 112 as much as possible under dual effects of a gravity of the second free end 132 of the second limiting member 13 and the second torsional spring, thus playing a role of limiting a position of the back end of the limiting rib 21.

Correspondingly, when the first free end 122 of the first limiting member 12 rotates into the first accommodating groove 111, the first free end 122 of the first limiting member 12 should overcome an elastic force of the first torsional spring 1211 and the gravity of the first limiting member 12. When the first limiting member 12 should be accommodated in steadily in the first accommodating groove 111 stably to give way to the limiting rib 21, the first limiting member 12 should be limited within the first accommodating groove 111. In the present embodiment, the inner surface of the first accommodating groove 111 can be provided with a locking part 1110. The locking part 1110 can be a hole or other common structures capable of locking. For example, in the present embodiment, the locking part 1110 can be a first locking hole 1112. The first free end 122 of the first limiting member 12 can be rotated upwards, so that the first limiting member 12 can be fully accommodated in the first accommodating groove 111 and the first free end 122 of the first limiting member 12 can align with the first locking hole 1112, and the first free end 122 of the first limiting member 12 can be locked within the first accommodating groove 111 by a bolt. At this time, when the second free end 132 of the second limiting member is located at the position below the second avoiding port 1121, then crystal bar holder 2 can convey the material backward from the front end of the holding seat 11, and the crystal bar holder 2 can be limited by the second free end 132 of the second limiting member.

Similarly, the inner surface of the second accommodating groove 112 can be provided with a locking part 1110, and the locking part 1110 can be a second locking hole 1112. When the second free end 132 of the second limiting member 13 is rotated to a position align with the second locking hole, the second free end of the second limiting member 13 can be locked by a bolt. At this time, the second limiting member 13 can be accommodated in the second accommodating groove 112. At this time, when the first free end 122 of the first limiting member is located below the first accommodating groove 111, the crystal bar holder 2 can convey the material forward from the back end of the holding seat 11, and the crystal bar holder 2 can be limited by the first free end 122 of the first limiting member.

Taking the first torsional spring 1211 as an example, it is understood that in some embodiments, since an elastic force the first torsional spring 1211 provides a moving trend of the first free end 122 of the first limiting member 12 to rotate into the first avoiding port 1111, the first limiting member 12 should be locked when the first free end 122 of the first limiting member 12 is located below the accommodating groove 111. Thus, the first free end 122 of the first limiting member 12 located outside the first accommodating groove 111 cannot be used as a locked position, so that a part of the first limiting member 12 adjacent to the first articulated end 121 of the first limiting member 12 (i.e., a part of the first limiting member 12 located in the first accommodating groove 111) should be locked on the inner surface of the first accommodating groove 111 by a bolt. Since the locked position is adjacent to the first articulated end 121 of the first limiting member 12, a force arm is short, and a requirement of locking force of the screw will be high.

As soon as the crystal bar holder 2 collides with the first free end 122 of the first limiting member 12 or the second free end 132 of the second limiting member 13 during the feeding process, the crystal bar holder 2 be blocked and controlled by a control board 18 to stop moving.

In view of above, when the first free end 122 of the first limiting member 12 is located in the first accommodating groove 111, and the second free end 132 of the second limiting member 13 is located in the second accommodating groove 112, the crystal bar holder 2 can slide forward from the back end of the holding seat 11 or slide backward from the front end of the holding seat 11 for feeding, but the crystal bar holder 2 cannot be limited. When the first free end 122 of the first limiting member 12 is located below the first accommodating groove 111 and the second free end 132 of the second limiting member 13 is located below the second accommodating groove 112, the crystal bar holder 2 will be limited by the first free end 122 rather than the second free end 132 of the second limiting member 13 while conveying the material backward from the front end of the holding seat 11: and, the crystal bar holder 2 will be limited by second free end 132 rather than the first free end 122 while conveying the material frontwards from the back end of the holding seat 11 In either case, the crystal bar holder 2 cannot reach a position on the holding seat 11 between the first free end 122 of the first limiting member 12 and a second free end 132 of the second limiting member 13, and the crystal bar holder 2 cannot get into the slicing chamber. Therefore, when the first free end 122 of the first limiting member 12 is located below the first accommodating groove 111, the second free end 132 of the second limiting member 13 must be located in the second accommodating groove 112. When the first free end 122 of the first limiting member 12 is located in the first accommodating groove 111, the second free end 132 of the second limiting member 13 must be located below the second accommodating groove 112.

Consequently, in the present embodiment, the inner surface of the first accommodating groove 111 can be provided with a first proximity switch 1221, and the first proximity switch 1221 can be configured to detect a distance between the first proximity switch 1221 and the first free end 122 of the first limiting member 12. The distance between the first proximity switch 1221 and the first free end 122 of the first limiting member 12 changes when the first free end 122 of the first limiting member 12 rotates. When the first free end 122 of the first limiting member 12 are detected by the first proximity switch 1221, the first free end 122 of the first limiting member 12 is located in the first accommodating groove 111. When the first free end 122 of the first limiting member 12 are not detected by the first proximity switch 1221, the first free end 122 of the first limiting member 12 is located below the first accommodating groove 111. Similarly, the inner surface of the second accommodating groove 112 can be provided with a second proximity switch 1321, and the second proximity switch 1321 can be configured to detect a distance between the second proximity switch 1321 and the second free end 132 of the second limiting member 13.

Referring to FIG. 13, both the first proximity switch 1221 and the second proximity switch 1321 can be electrically connected to a control board 18, and the control board 18 can be electrically connected to an alarm 19. When signals are simultaneously detected by the first proximity switch 1221 and the second proximity switch 1321, respectively, the alarm 19 can be controlled by the control board 18 to sound. When signals cannot be detected by the first proximity switch 121 and the second proximity switch 1321 at the same time, the alarm 19 can be controlled by the control board 18 to sound. When the first free end 122 of the first limiting member 12 is detected by the first proximity switch 1221, or the second free end 132 of the second limiting member 13 is detected by the second proximity switch 1321, it is not necessary to control the alarm 19 to sound.

Alternatively, in the present embodiment, in order to facilitate alignment and locking between the first free end 122 of the first limiting member 12 and the first locking hole 1112, and alignment and locking between the second free end 132 of the second limiting member 13 and the second locking hole, when the first free end 122 of the first limiting member 12 aligns with the first locking hole 1112, the first limiting member 12 can abut against the inner surface of the first accommodating groove 111; and when the second free end 132 of the second limiting member 13 aligns with the second locking hole, the second limiting member 13 can abut against the inner surface of the second accommodating groove 112.

As an alternative embodiment of alignment between the first free end 122 of the first limiting member 12 and the first locking hole 1112, and alignment between the second free end 132 of the second limiting member 13 and the second locking hole, the inner surface of the accommodating groove 110 can be provided with a blocking member 114. When the at least two limiting members are in the avoiding state, the limiting members can abut against the blocking member 114. Specifically, the inner surface of the first accommodating groove 111 can be provided with a first blocking member. When the first free end 122 of the first limiting member 12 aligns with the first locking hole 1112, the first limiting member 12 can abut against the first blocking member. The inner surface of the second accommodating groove 112 can be provided with a second blocking member. When the second free end 132 of the second limiting member 13 aligns with the second locking hole, the second limiting member 13 can abut against the second blocking member.

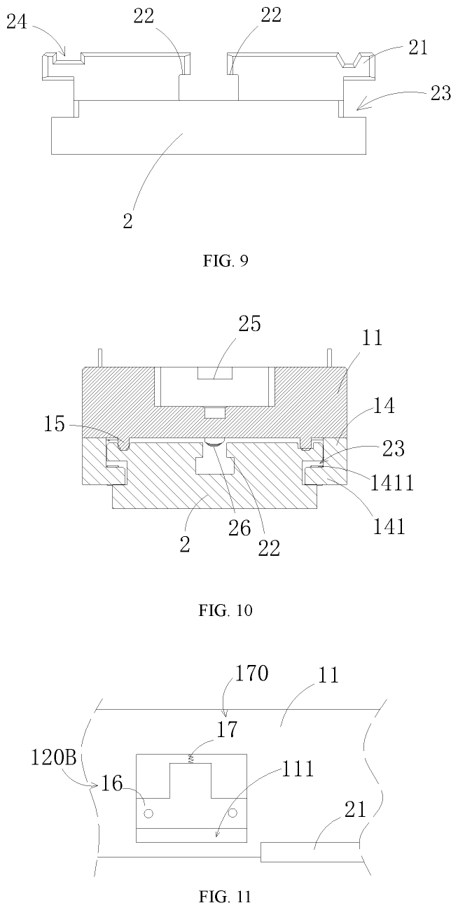

Referring to FIG. 3, in the present embodiment, a top end of the holding seat 11 can be provided with a cylinder groove 113, and a lifting cylinder 25 can be disposed in the cylinder groove 113. The lifting cylinder 25 can be an air cylinder or an oil cylinder. Referring to FIG. 8 to FIG. 9, the top end of the crystal bar holder 2 can include a lifting step 22. A power output end of the lifting cylinder 25 can be located below the lifting step 22, so that the entire crystal bar holder 2 can be lifted by the lifting step 22.

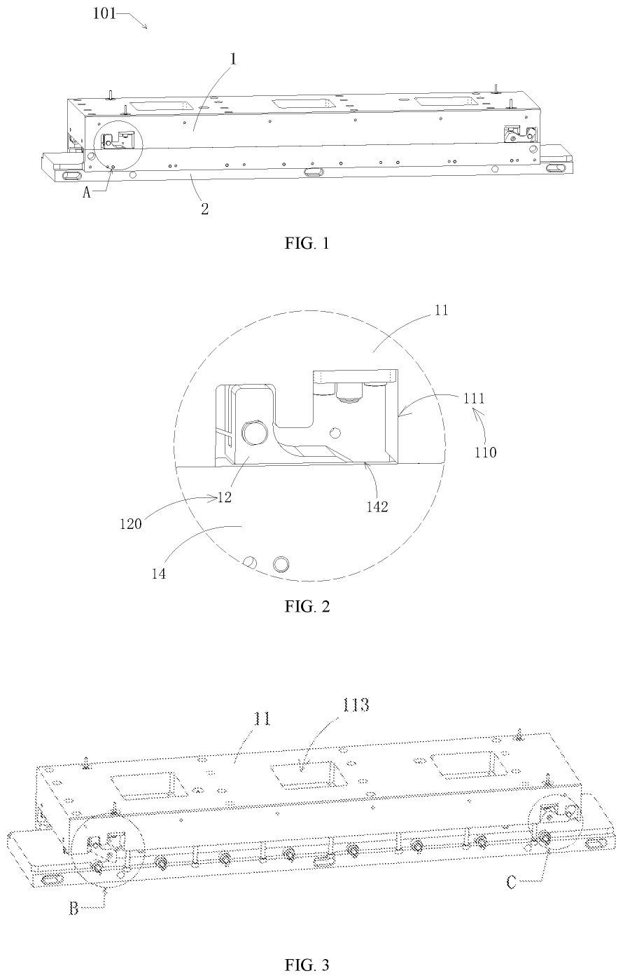

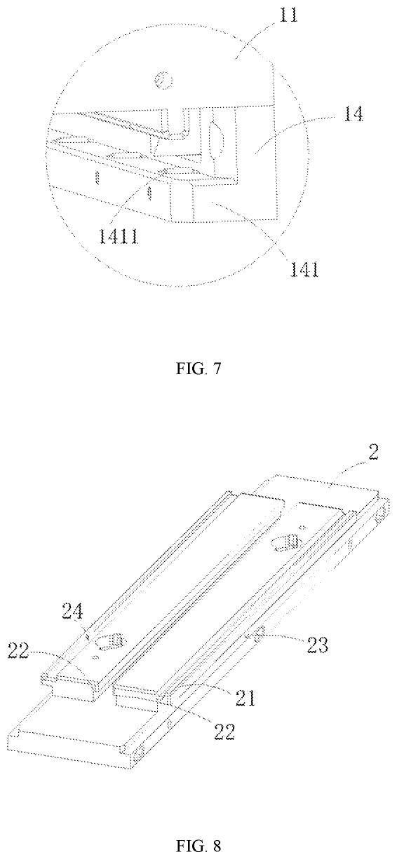

Referring to FIG. 2, FIG. 6, FIG. 7 and FIG. 10, the holding mechanism 1 can further include a connecting plate 14. An edge of a top end of the connecting plate 14 can be fixed to an edge of the bottom surface of the holding seat 11. An edge of a bottom end of the connecting plate 14 can extend to define a sliding plate 141, the sliding plate 141 can be provided with an idler wheel 1411, and the sliding plate 141 can be located at a side of the connecting plate 14 adjacent to the holding seat 11. An edge of the crystal bar holder 2 can be provided with a sliding groove 23, and the idler wheel 1411 can be located in the sliding groove 23.

When the crystal bar holder 2 moves on the holding seat 11, the lifting cylinder 25 can move the crystal bar holder 2 down, so that a top surface of the sliding groove 23 can be in contact with a top end of the idler wheel 1411, and the idler wheel 1411 can play a role of lifting the crystal bar holder 2. When the crystal bar holder 2 moves on the holding seat 11, part of a sliding friction force between the lifting cylinder 25 and the lifting step 22 can be converted into a rolling friction force between the top surface of the sliding groove 23 and the idler wheel 1411, thereby reducing resistance of movement of the crystal bar holder 2. When the crystal bar holder 2 moves to a certain position along the axis of the crystal bar holder, the lifting cylinder 25 can lift the crystal bar holder 2 to separate the top surface of the sliding groove 23 from the idler wheel 1411 until a bottom surface of the sliding groove 23 is in contact with the idler wheel 1411, so that the holding seat 11 and the crystal bar holder 2 can be tightly held along a vertical direction. In this way, the crystal bar can be stably and smoothly sliced in the slicing chamber.

Alternatively, a third proximity switch 26 can be disposed on the bottom surface of the holding seat 11, and the third proximity switch 26 can be configured to detect a distance between the crystal bar holder 2 and the bottom surface of the holding seat 11, so as to determine whether the crystal bar holder 2 and the holding seat 11 are tightly held along the vertical direction.

Furthermore, the top end of the crystal bar holder 2 can be provided with a limiting groove 24, and the bottom surface of the holding seat 11 can be provided with a limiting bar 15. When the crystal bar holder 2 and the holding seat 11 are tightly held along the vertical direction, the limit bar 15 can be located in the limiting groove 24, thereby positioning the crystal bar holder 2 along a width direction of the holding mechanism 1, and further stabilizing a position of the crystal bar holder 2 in a slicing process of the crystal bar.

Since both the first accommodating groove 111 and the second accommodating groove 112 are provided on the sidewall of the holding seat 11, the first accommodating groove 111 and the second accommodating groove 112 will not be obscured by the connecting plate 14. In this way, the first locking hole 1112 and the second locking hole can be guaranteed to be exposed, so that the first free end 122 of the first limiting member 12 and a second free end 132 of the second limiting member 13 can be locked without being affected. However, referring to FIG. 2, since the connecting plate 14 is located directly below the first avoiding port 1111 and the second avoiding port 1121, in order to prevent the connecting plate 14 from obstructing movement of the first free end 122 of the first limiting member at the first avoiding port 1111, and prevent the connecting plate 14 from obstructing movement of the second free end 132 of the second limiting member, a side surface of the connecting plate 14 can concave to define an avoiding notch 142 at the edge of the top end of the connecting plate 14. The avoiding notch 142 can be located below the first accommodating groove 111 and the second accommodating groove 112 to allow the first free end 122 of the first limiting member and the second free end 132 of the second limiting member to move.

### Second Embodiment

Compared with the First embodiment, the present embodiment provides an operation state of the limiting member. In the present embodiment, the limiting member can include a free end 120B and a positioning end 170. The positioning end 170 of the limiting member can be fixed to the inner surface of the accommodating groove, and the free end 120B of the limiting member can move linearly relative to the positioning end 170, thereby getting in or getting out of the accommodating groove, so that the limiting member can switch between the avoiding state and the limiting state.

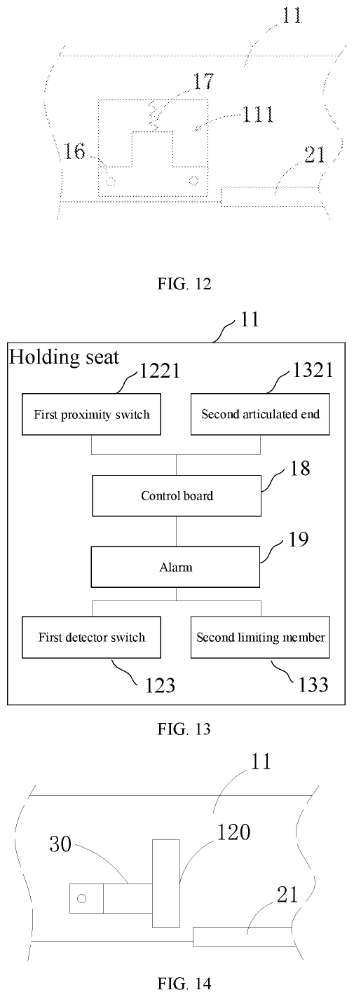

Referring to FIG. 11 and FIG. 12, in the present embodiment, the limiting member can include a limiting block 16 and a recovering spring 17. Two ends of the recovering spring 17 can be mounted on the inner surface of the accommodating groove and the limiting block 16, respectively. An end of the recovering spring 17 mounted on the inner surface of the accommodating groove can be defined as the positioning end 170 of the limiting member, and the limiting block 16 can be defined as the free end 120B of the limiting member. The limiting block 16 can merely move along a straight line under an action of the recovering spring 17.

In the present embodiment, the holding seat 11 can be provide with a first accommodating groove 111 and a second accommodating groove along the length direction of the holding seat 11. Taking the first accommodating groove 111 as an example, the limiting block 16 can move down under dual effects of the gravity of the limiting block 16 and the recovering spring 17. Therefore, a bottom end of the limiting block 16 can be stably disposed corresponding to the end of the limiting rib 21, so that the limiting member is in the limiting state, providing a stable limiting effect on the limiting rib 21. The inner surface of the first accommodating groove 111 can be provided with a locking part. When the gravity of the limiting block 16 and an elasticity of the recovering spring 17 are artificially overcame to lift the limiting block 16, the limiting member can be in the avoiding state. At this moment, the limiting block 16 can be completely accommodated in the first accommodating groove 111, and the limiting block 16 can be locked at the locking part simultaneously, so that the limiting block 16 can fully give way to the limiting rib 21.

Alternatively, a part of the outer surface of the limiting block 16 can fit with the inner surface of the first accommodating groove 111, so that the inner surface of the first accommodating groove 111 can be capable of guiding movement of the limiting block 16, thereby reducing deflection of the limiting block 16 during the movement of the limiting block 16, and limiting the limiting rib 21 more precisely. Compared with the First embodiment, in the present disclosure, when the limiting rib 21 collides with the limiting block 16, since a direction of the movement of the limiting block 16 is perpendicular to a direction of movement of the limiting rib 21, the limiting block 16 cannot move, thereby providing a better limiting effect on the limiting rib 21.

In the present embodiment, the inner surface of the first accommodating groove 111 can be provided with a first detector switch 123, and the inner surface of the second accommodating groove can be provided with a second detector switch 133. The first detector switch 123 can be configured to detect a state of the first limiting member, and the second detector switch 133 can be configured to detect a state of the second limiting member. In the present embodiment, the first detector switch 123 and the second detector switch 133 may be a proximity switch, a microswitch, or other switchs known in the art.

Referring to FIG. 13, both the first detector switch 123 and the second detector switch 133 can be electrically connected to the control board 18, and the control board 18 can be electrically connected to an alarm. When both the first limiting member and the second limiting member are in the avoiding state and detected by the first detector switch 123 and the second detector switch 133, respectively, the alarm can sound. When both the first limiting member and the second limiting member are in the limiting state and detected by the first detector switch 123 and the second detector switch 133, respectively, the alarm can sound.

In other embodiments, the limiting member can be an extendable tube. An end of the extendable tube can be defined as the free end 120B of the limiting member, and the other end of the extendable tube can be defined as the positioning end 170 of the limiting member. The extendable tube can extend by gravity, so as to switch to the limiting state and the extendable tube can be shortened to switch to the avoiding state.

### Third Embodiment

Differences between the present embodiment, the First embodiment and the Second embodiment are shown hereinafter. Referring to FIG. 14, movement of the limiting member in the present embodiment does not depend on gravity of the limiting member, a torsional spring or a recovering spring. In the present embodiment, an electric actuator 30 can be provided on the holding seat 11, and the limiting member 120 can be provided on the electric actuator 30. The limiting member can be controlled by the electric actuator 30 to move or rotate, so that the limiting member can switch between the avoiding state and the limiting state.

The electric actuator 30 can be a motor, or an electric expansion link, and the electric actuator 30 can be selected according to actual needs or a structural design by those skilled in the art.

Since the state of the limiting member is controlled by the electric actuator 30, the limiting member is less prone to move when the limiting rib collides with the limiting member, thus improving a limiting effect of the limiting member. In addition, the state of the limiting member 120 can be directly monitored by the electric actuator 30, it is not necessary to provide the first detector switch 123 and the second detector switch 133.

### Fourth Embodiment

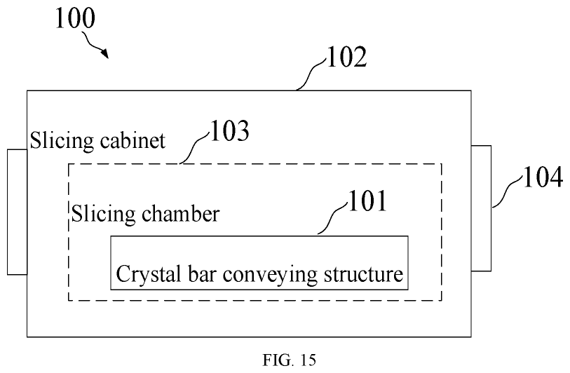

Referring to FIG. 15, the present embodiment provides a slicer 100, which includes the crystal bar conveying structure 101 in the First embodiment, the Second embodiment or the Third embodiment and a slicing cabinet 102. The slicing cabinet 102 can be provided with a slicing chamber 103. Both a front sidewall of the slicing cabinet 102 and a back sidewall of the slicing cabinet 102 can be provided with ports 104, and the ports 104 can be connected to and in communication with the slicing chamber 103. The crystal bar holder can move backward from the front end of the holding seat, thereby entering the slicing chamber 103 from the port 104 on the front sidewall of slicing cabinet 102. Alternatively, the crystal bar holder can move forward from the back end of the holding seat, thereby entering the slicing chamber 103 from the port 104 on the back sidewall of slicing cabinet 102.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. A holding mechanism of a slicer, comprising a holding seat and at least two limiting members,
wherein the at least two limiting members are movably disposed on the holding seat;
an outer surface of the holding seat is provided with an accommodating groove, each of the at least two limiting members has an avoiding state and a limiting state;
when the at least two limiting members are in the avoiding state, at least a part of each of the at least two limiting members is accommodated in the accommodating groove, so as to give way to a crystal bar holder in a moving process of the crystal bar holder;
when the at least two limiting members are in the limiting state, at least a part of each of the at least two limiting members protrudes out from the outer surface of the holding seat to abut against the crystal bar holder, and
the at least two limiting members comprises a first limiting member and a second limiting member, and the first limiting member and the second liming member are disposed at intervals along a length direction of the holding seat.

2. The holding mechanism of the slicer of claim 1, wherein each of the at least two limiting members comprises an articulated end and a free end, the articulated end of the at least two limiting members is pivotally connected to an inner surface of the accommodating groove, a torsional spring is sleeved on the articulated end of the at least two limiting members, and two ends of the torsional spring are located on the inner surface of the accommodating groove and the free end, respectively.

3. The holding mechanism of the slicer of claim 2, wherein the inner surface of the accommodating groove is provided with a locking part, and when the at least two limiting members are in the avoiding state, the free ends of the at least two limiting members are locked to the locking part.

4. The holding mechanism of the slicer of claim 2, wherein when the at least two limiting members are in the avoiding state, the at least two limiting members abut against the inner surface of the accommodating groove; or,
the inner surface of the accommodating groove is provided with a blocking member, when the at least two limiting members are in the avoiding state, the at least two limiting members abut against the blocking member.

5. The holding mechanism of the slicer of claim 2, wherein the holding seat is provided a first proximity switch and a second proximity switch,
the first proximity switch is configured to detect a distance between the first proximity switch and a free end of the first limiting member,
the second proximity switch is configured to detect a distance between the second proximity switch and a free end of the second limiting member, both the first proximity switch and the second proximity switch are electrically connected to a control board, and the control board is electrically connected to an alarm, wherein when both the free end of the first limiting member and the free end of the second limiting member are detected by the first proximity switch and the second proximity switch, respectively, the alarm sounds, or,
when both the free end of the first limiting member and the free end of the second limiting member are not detected by the first proximity switch and the second proximity switch, respectively, the alarm sounds.

6. The holding mechanism of the slicer of claim 1, wherein each of the at least two limiting members comprises a free end and a positioning end, the positioning end of each of the at least two limiting members is fixed to an inner surface of the accommodating groove, and the free end of each of the at least two limiting members is capable of getting in or getting out of the accommodating groove, so that each of at least two limiting members is switched between the avoiding state and the limiting state.

7. The holding mechanism of the slicer of claim 6, wherein each of the at least two limiting members comprises a limiting block and a recovering spring, an end of the recovering spring is defined as the positioning end, the other end of the recovering spring is disposed on the limiting block, so that the limiting block is defined as the free end.

8. The holding mechanism of the slicer of claim 7, wherein the inner surface of the accommodating groove is provided with a locking part, and
when the at least two limiting members are in the avoiding state, the limiting block is locked at the locking part.

9. The holding mechanism of the slicer of claim 7, wherein a part of an outer surface of the limiting block fits with the inner surface of the accommodating groove, so that the inner surface of the accommodating groove is capable of guiding movement of the limiting block.

10. The holding mechanism of the slicer of claim 6, wherein each of the at least two limiting members is an extendable tube, an end of the extendable tube is defined as the free end of the at least two limiting members, and the other end of the extendable tube is defined as the positioning end of the at least two limiting members.

11. The holding mechanism of the slicer of claim 6, wherein the inner surface of the accommodating groove is provided with a first detector switch and a second detector switch,
the first detector switch is configured to detect a state of the first limiting member, the second detector switch is configured to detect a state of the second limiting member, both the first detector switch and the second detector switch are electrically connected to a control board, the control board is electrically connected to an alarm, wherein
when both the first limiting member and the second limiting member are in the avoiding state and detected by the first detector switch and the second detector switch, respectively, the alarm sounds, or,
when both the first limiting member and the second limiting member are in the limiting state and detected by the first detector switch and the second detector switch, respectively, the alarm sounds.

12. The holding mechanism of the slicer of claim 1, wherein the holding seat is provided with an electric actuator, the at least two limiting members are disposed on the electric actuator, and the electric actuator is configured to control the at least two limiting members to switch between the avoiding state and the limiting state.

13. The holding mechanism of the slicer of claim 1, wherein the holding seat is provided with a lifting cylinder configured to lift the crystal bar holder, a third proximity switch is disposed on a bottom surface of the holding seat, and the third proximity switch is configured to detect a distance between the crystal bar holder and the bottom surface of the holding seat.

14. The holding mechanism of the slicer of claim 13, wherein the holding mechanism further comprises a connecting plate, an edge of a top end of the connecting plate is fixed to an edge of a bottom end of the holding seat, an edge of a bottom end of the connecting plate extends to define a sliding plate, the sliding plate is provided with an idler wheel, and the sliding plate is located at a side of the connecting plate adjacent to the holding seat.

15. A crystal bar conveying structure, comprising a holding mechanism and a crystal bar holder of claim 1,
wherein the crystal bar holder is movably disposed on a bottom of the holding seat along a length direction of the holding seat.

16. A slicer, comprising a slicing cabinet and a crystal bar conveying structure of claim 15, wherein both a front sidewall of the slicing cabinet and a back sidewall of the slicing cabinet are provided with ports, and the ports are configured to allow a material to get in or out.
